(19) United States
(12) Patent Application Publication
(10) Pub. No.: US 2016/0136526 A1
(43) Pub. Date: May 19, 2016

(54) Perpetual Gaming Platform

(71) Applicant: Forget You Not, LLC, Waban, MA (US)

(72) Inventors: Richard J.W. Mansfield, Cambridge, MA (US); Nissim Shani, Waban, MA (US); Daniel Shani, Waban, MA (US); Roni Shani, Waban, MA (US)

(21) Appl. No.: 14/540,256

(22) Filed: Nov. 13, 2014

(51) Int. Cl. A63F 13/847

(52) U.S. Cl. CPC A63F 13/847

(57) ABSTRACT

A method includes playing a game with a second person on behalf of a first person using a digital representation of the first person; and on behalf of the first person and using the digital representation of the first person, while playing the game with the second person, providing a natural language response to a question or statement from the second person based on information from or about the first person.

### BACKGROUND

This description relates generally to social network environments.

### SUMMARY

In an aspect, a method includes playing a game with a second person on behalf of a first person using a digital representation of the first person; and on behalf of the first person and using the digital representation of the first person, while playing the game with the second person, providing a natural language response to a question or statement from the second person based on information from or about the first person.

Embodiments may include one or more of the following features.

The method includes presenting the digital representation of the first person. The digital representation of the first person includes one or more of an audio representation, a still image representation, or a video representation of the first person.

Playing the game with the second person comprises playing the game at a level of play at which the first person plays or played the game. The method includes determining the level of play of the first person. The method includes determining the level of play of the first person based on a previous observation of the first person playing the game

Playing the game with the second person includes presenting a gesture or physical action during the game. The method includes presenting the gesture or physical action in a video or multimedia display. The method includes determining the gesture or physical action based on information received from or about the first person. The method includes determining the gesture or physical action based on a previous observation of the first person playing the game. The method includes presenting the gesture or physical action in response to a question, statement, or action from the second person. The method includes determining the gesture or physical action based on the question, statement, or action from the second person. The method includes presenting the gesture or physical action in response to an event that occurred during the game.

The method includes presenting a still or video image of the first person while playing the game with the second person.

The method includes inviting the second person to play the game. The method includes determining an identity of the second person based on information indicative of the identity of the second person previously provided by the first person.

The method includes receiving a request from the second person to play the game. The method includes determining whether to accept the request from the second person. The method includes accepting the request if information previously provided by the first person included information indicative of the identity of the second person.

Providing the natural language response comprises providing at least a portion of a digitized life history previously provided by the first person. The method includes determining the portion of the digitized life history based on the question or statement from the second person.

Providing the natural language response comprises providing the natural language response in a manner associated with the first person. The method includes determining the manner in which to provide the natural language response based on the information received from or about the first person. The manner associated with the first person includes one or more of a manner of speaking by the first person or a gesture used by the first person. The manner of speaking includes one or more of voice of the first person, an accent of the first person, or a tone of voice of the first person.

The method includes playing the game with the second person on behalf of the first person when the first person is no longer alive or no longer competent.

In an aspect, a system includes a processor coupled to a memory, the processor and memory configured to play a game with a second person on behalf of a first person using a digital representation of the first person; and on behalf of the first person and using the digital representation of the first person, while playing the game with the second person, providing a natural language response to a question or statement from the second person based on information from or about the first person.

In an aspect, a computer readable medium stores instructions for causing a computing system to play a game with a second person on behalf of a first person using a digital representation of the first person; and on behalf of the first person and using the digital representation of the first person, while playing the game with the second person, providing a natural language response to a question or statement from the second person based on information from or about the first person. These and other aspects, features, implementations, and advantages, and combinations of them, can be expressed as methods, apparatus, systems, components, program products, business methods, and means or steps for performing functions, or combinations of them.

Other features, aspects, implementations, and advantages will become apparent from the description, the drawings, and the claims.

### DESCRIPTION

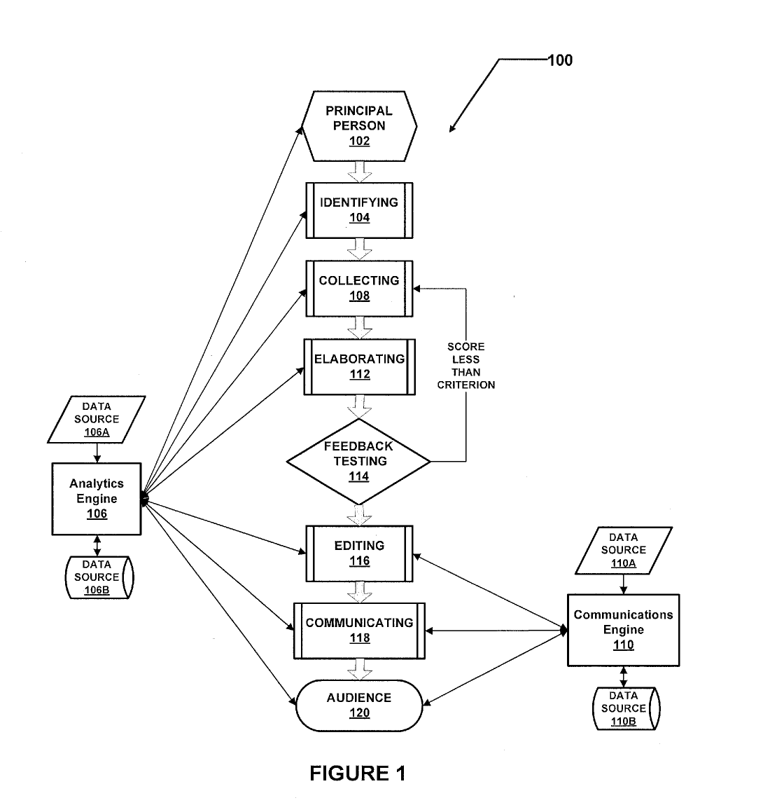

FIG. 1 is a flowchart for developing an intelligent avatar for life history recording, transformation, and publishing in digital interactive format.

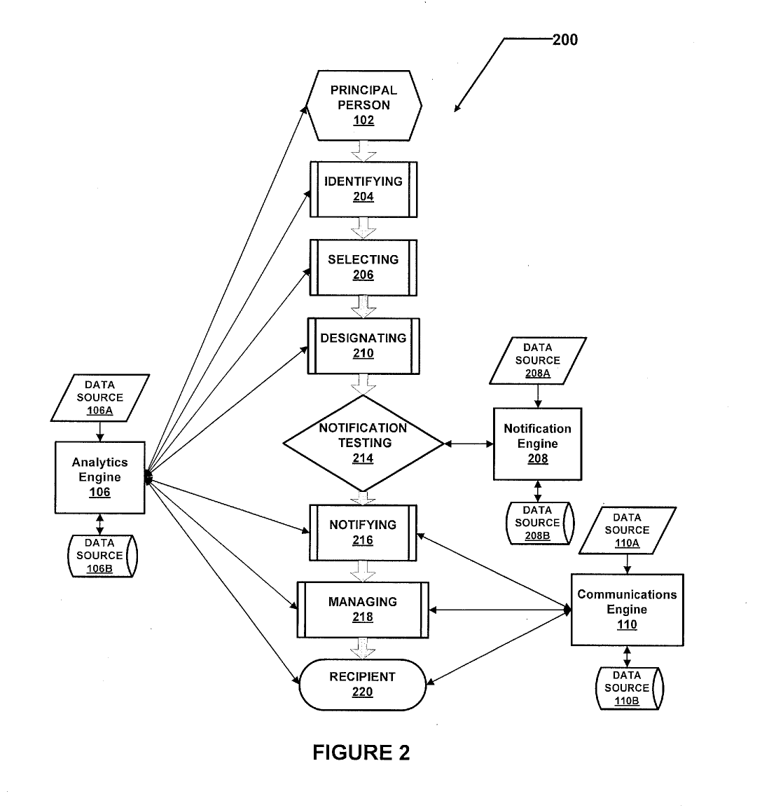

FIG. 2 is a flowchart for imparting advance directives to an intelligent surrogate for execution at a future time.

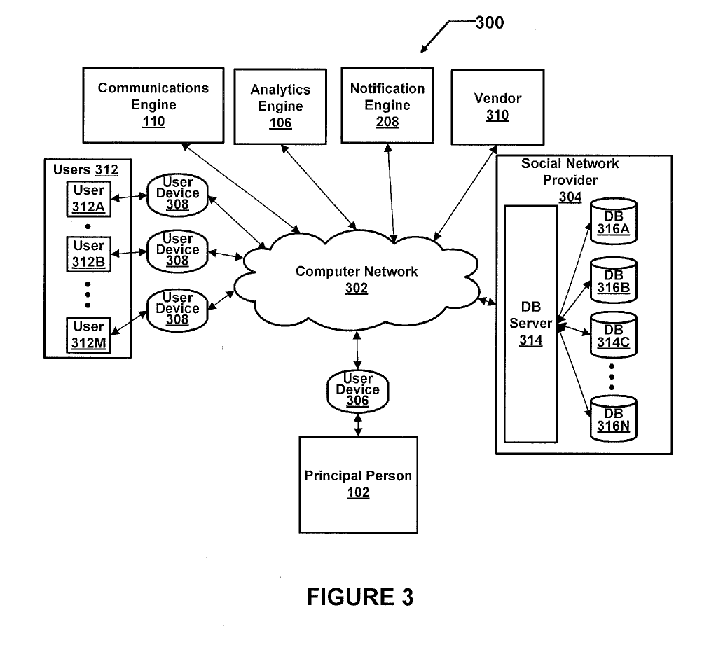

FIG. 3 is a block diagram of a social network or other system.

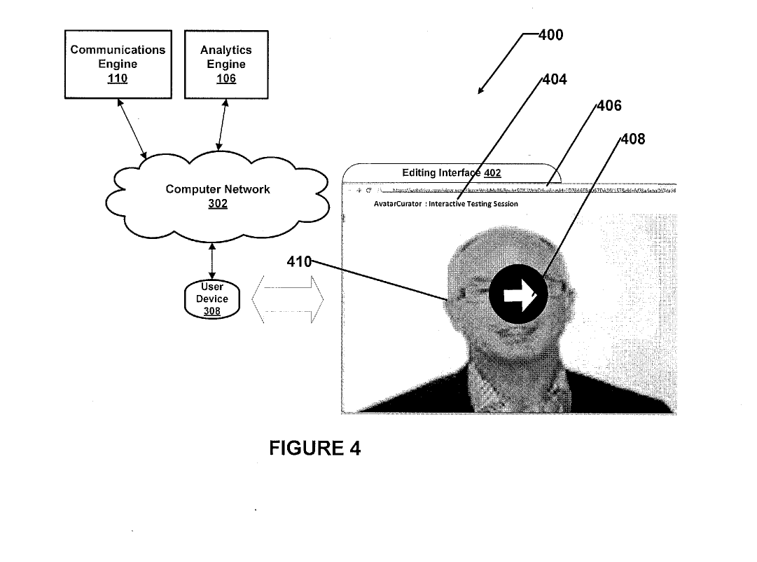

FIG. 4 is a view of an editing interface for avatar construction and surrogate development.

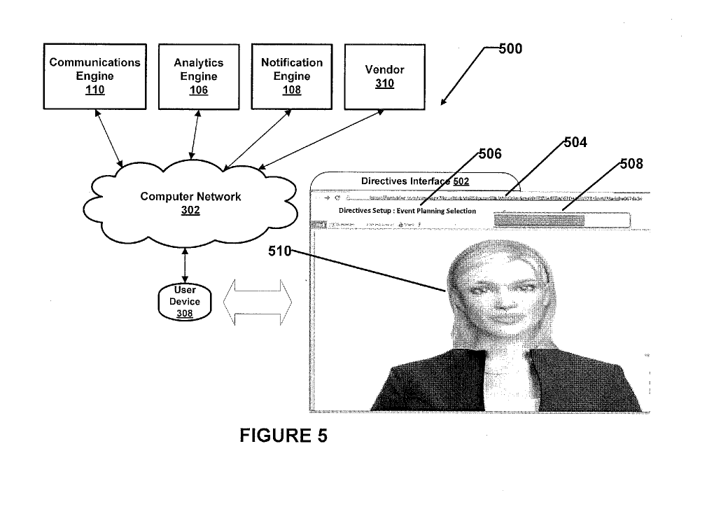

FIG. 5 is a view of an editing interface for entering surrogate directives.

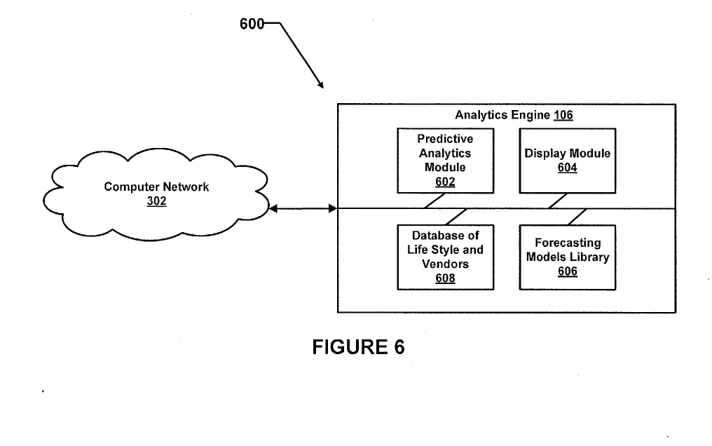

FIG. 6 is a block diagram of an analytics engine.

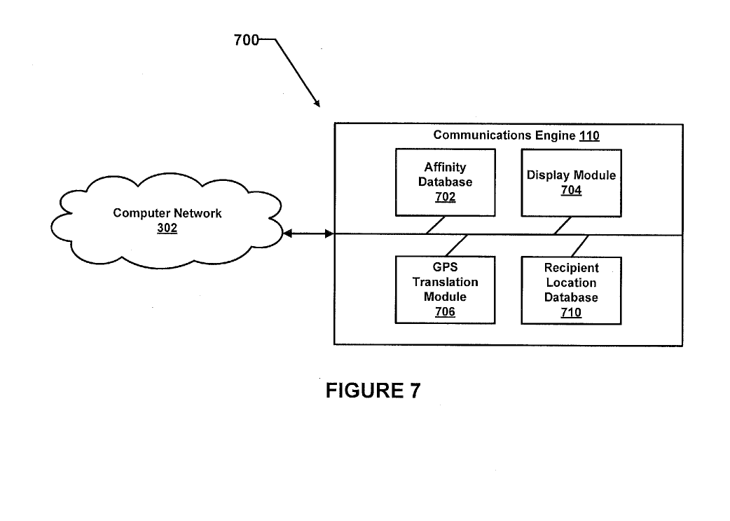

FIG. 7 is a block diagram of a communication engine.

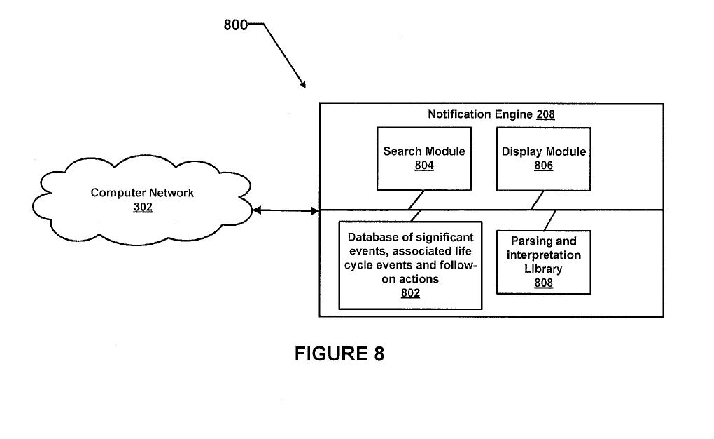

FIG. 8 is a block diagram of a notification engine.

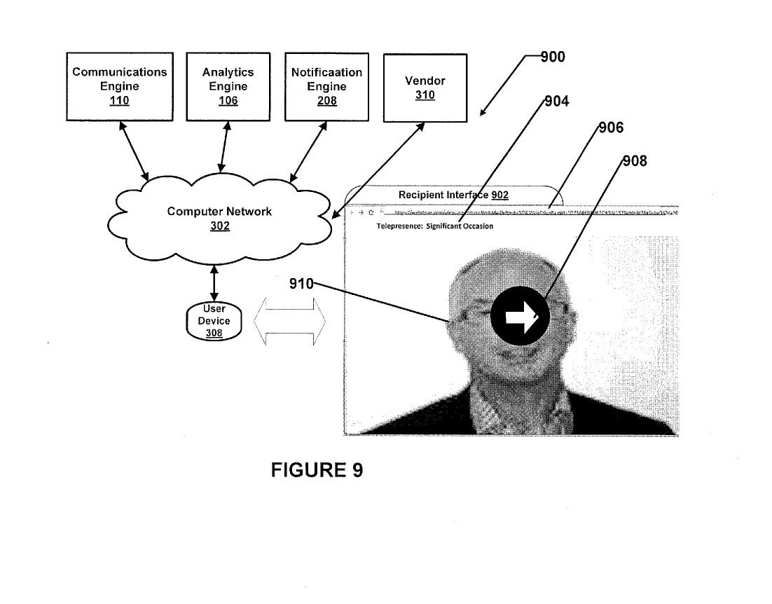

FIG. 9 is a view of the recipient interface.

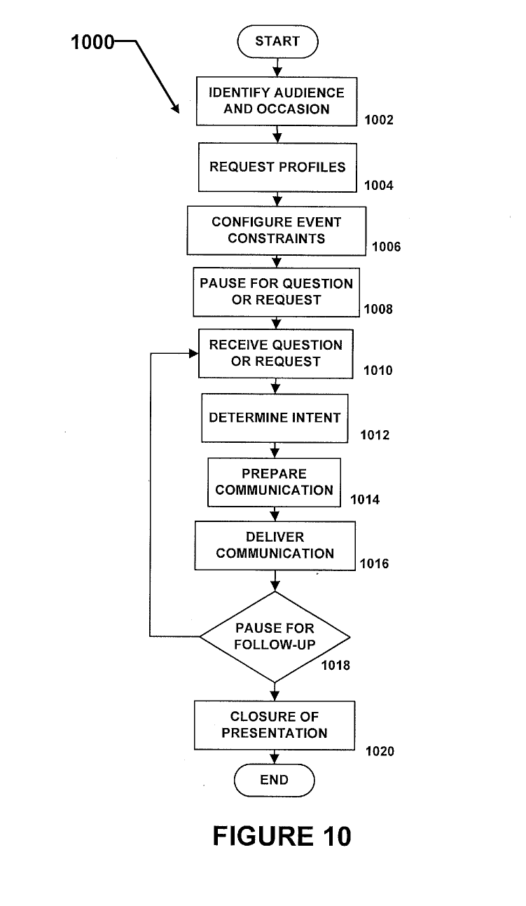

FIG. 10 is a flowchart for delivering presentations.

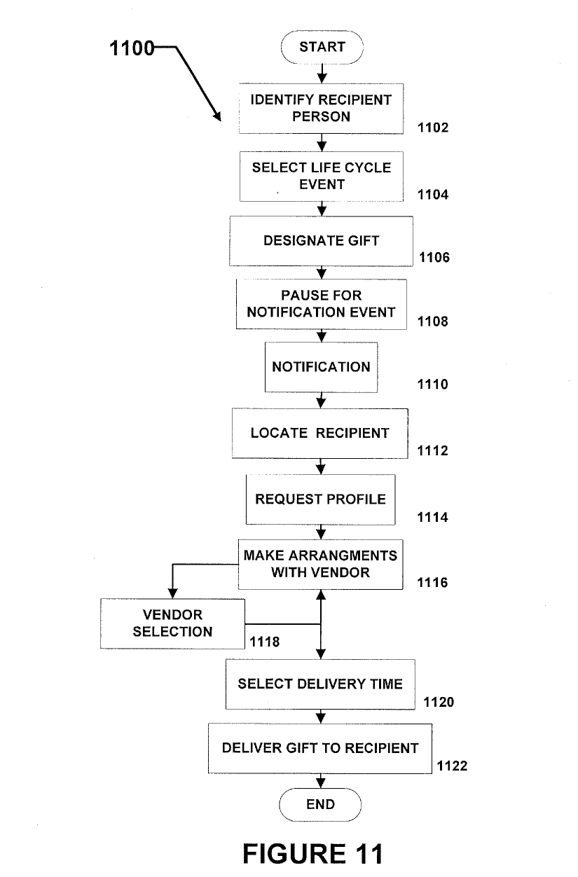

FIG. 11 is flowchart for delivering gifts.

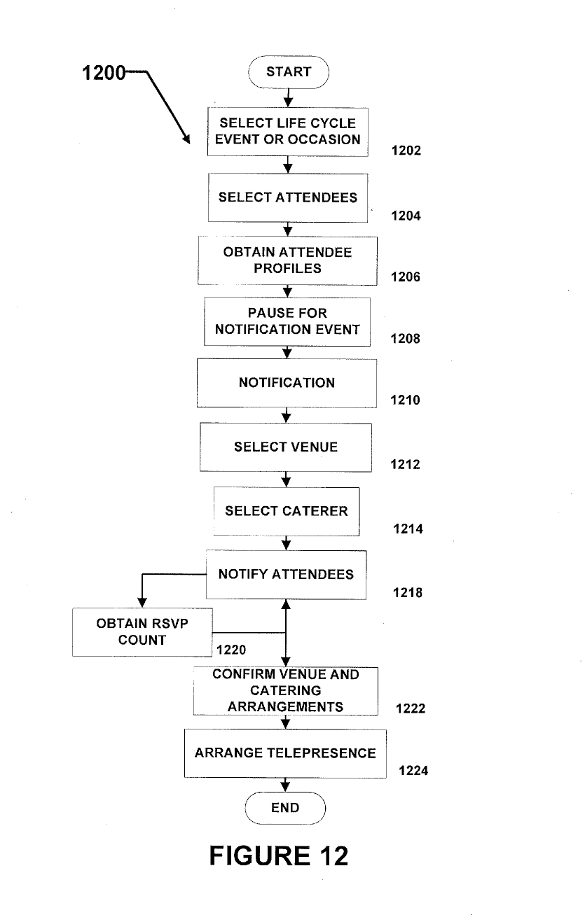

FIG. 12 is a flowchart for managing an event directive.

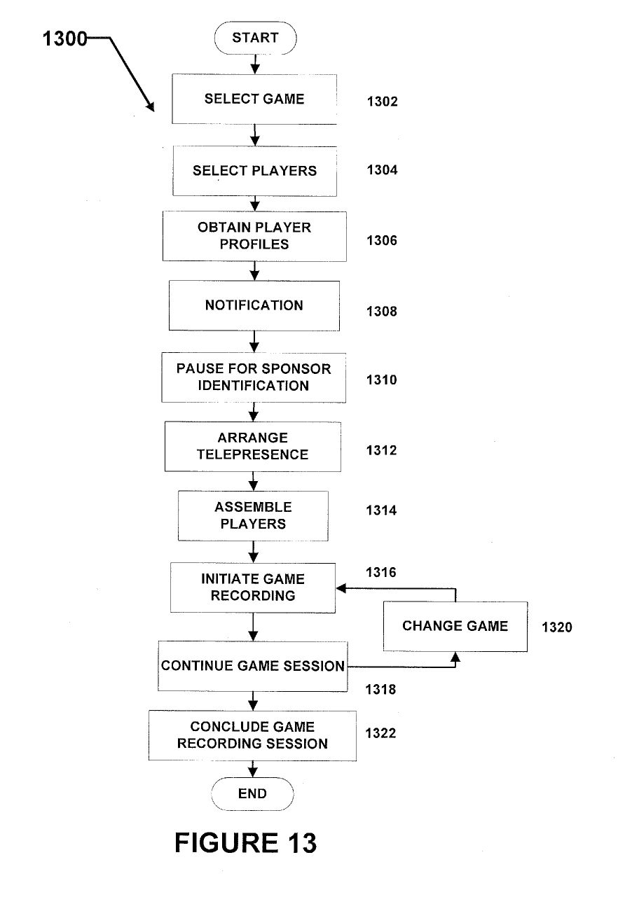

FIG. 13 is a flowchart for managing an interactive game.

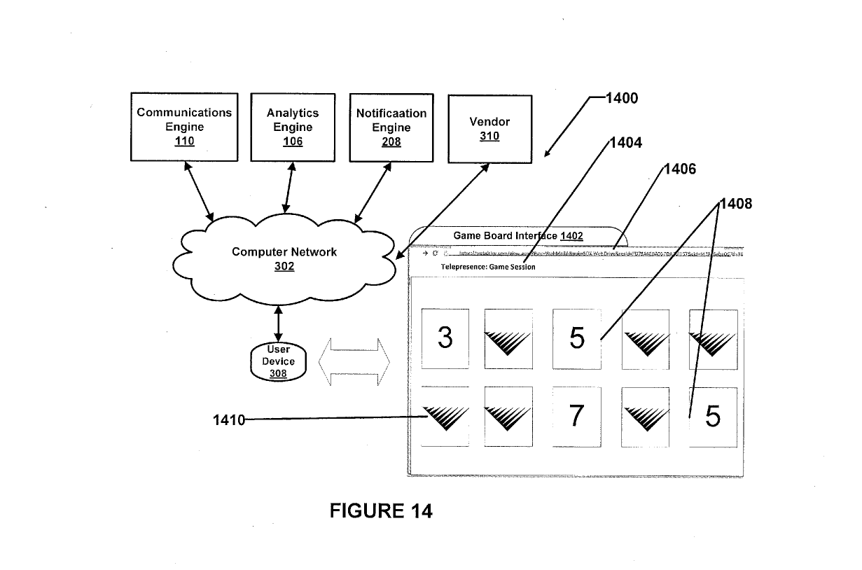

FIG. 14 shows a game display.

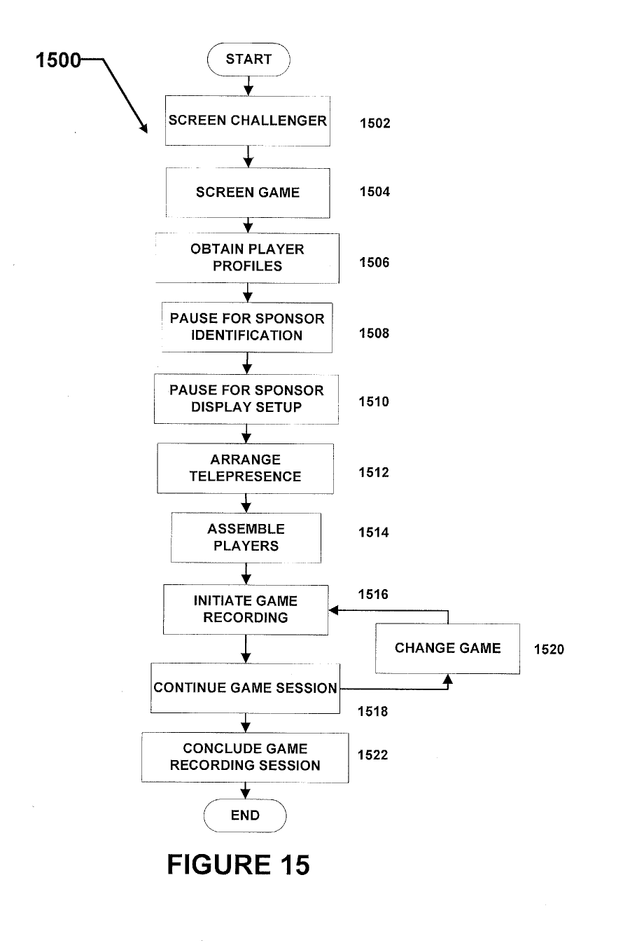

FIG. 15 is a flowchart for managing an invitation to a game.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of the invention.

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

When a single device or article is described, more than one device/article (whether or not they cooperate) may be used in place of a single device/article. Similarly, where more than one device or article is described (whether or not they cooperate), a single device/article may be used in place of the more than one device or article.

Techniques and mechanisms described or reference herein will sometimes be described in singular form for clarity. However, particular embodiments include multiple iterations of a technique or multiple instantiations of a mechanism unless noted otherwise.

The system described here enables a person to imbue a surrogate to play a game on behalf of the person. The surrogate can be matched with the person in digital appearance, voice, or manner, or a combination of any two or more of them. The surrogate can use the person's personal knowledge, expertise, and game playing skill in order to play the game on the person's behalf. For instance, if the person is an expert poker player but only a beginning chess player, the surrogate can play poker on behalf of the person at an expert level and can play chess on behalf of the person at a beginner level.

The surrogate can play the game with other players, such as real people or surrogates of other people. The surrogate can determine a move or action in the game based on a move or action in the game by one or more of the other players. For instance, when the person's surrogate is playing a checkers game, the surrogate will determine its next move based on its opponent's last move and based on the skill level of the person.

The surrogate can interact with the players during game play. For instance, the surrogate can be manifested as a personalized digital avatar that can respond to natural language questions or comments from the other players of the game. The avatar can respond based on information about the person, such as the person's opinions on certain issues, the person's memories, jokes the person told, or other information.

In an example, an elderly person (e.g., a grandfather) can imbue a surrogate with his game playing abilities, video recordings of his gestures and behaviors during game play, memories of past game play, or other information. In the future, e.g., after the grandfather has passed away, the grandfather's family can play a game with the grandfather's surrogate. The grandfather's surrogate plays the game at the level at which the grandfather used to play the game and can exhibit the same behaviors and gestures that the grandfather used to exhibit while playing the game. The grandfather's surrogate can engage in a conversation with the grandfather's family during game play, e.g., sharing his memories of playing the game, joking with his family, responding to questions about his life story, or engaging with his family in another way.

The system described here enables members of a community of users on a network to imbue a surrogate, which is matched in digital appearance, voice, and manner, with their personal knowledge, expertise and discernment in order to carry out the user's directives and intent at some predetermined future time. For example, a senior user with access to a social media network may embed his life story in digital format together with a personalized digital avatar to present that life story or portions thereof in response to natural language questions and using an intelligent surrogate to act on the senior's behalf to carry out the senior's directives in the future after the senior dies or becomes incompetent. For example, a senior user with access to a social media network may embed his game playing prowess in digital format in response to natural language questions and visual game configurations and using an intelligent surrogate to act on the senior's behalf to carry out the senior's directives at the comparable level of skill at known or similar games in the future after the senior dies or becomes incompetent.

FIG. 1 shows the conceptual framework 100 of the interaction of the system with the principal person 102 for extracting and transforming a life history of the principal person. In some cases, the system can extract and transform game playing approaches of the principal person, such as game playing strategies or abilities or both for one or more games. The principal person 102 logs onto the system and answers some standard identification questions, 104, so the system aided by the analytic engine 106 can search for relevant internet accessible information on the individual and events that occurred during his lifetime found in external data sources 106A or currently in internal data sources 106B. The system then progresses to collecting answers, 108 to autobiographical questions, which cover aspects usually published in a biographical note or obituary article. To assist the principal person 102 in answering the questions and to be consistent with the historical record, the system aided by the analytic engine 106 assembles material from internal data sources 106B or internet accessible data sources 106A about the principal person 102 or the events and presents that informational material along with the questions. One or more images of the principal person 102, in some cases along with one or more verbal answers from the principal person 102, are collected digitally by the system 108. The system then progresses to more personal, individual questions presented by an interrogation avatar during a session of elaboration 112 with whom the principal person 102 is relaxed and comfortable. The interrogation avatar, which is generated by the analytics engine 106 using techniques similar to those for LivingActor™ and can be selected by gender, age, ethnicity, voice type and other variables, is programmed with natural language understanding similar to that of Apple's SIRI or Nuance communications Systems' Nuance Interactive Natural Assistant (Nina™), and exhibit a number of behavioral expressions as do those avatars of LivingActor™ in response to the answers of the principal person 102. This elaboration 112 of autobiographical information then uses a third set of open-ended questions presented by the interrogation avatar to elicit life stories, such as those recorded by StoryCorps, covers more personal topics, such as “What is you earliest memory?”, “Who was your favorite teacher?” “What is your favorite flavor of ice cream?”, “What was it like growing up in [neighborhood, city, region, wartime, depression]? The elaboration 112 using the analytic engine 106 can interactively expand upon the questions along the lines of Weizenbaum's ELIZA program but in a more sophisticated manner guiding the principal person 102 through a series of life experiences, which may including playing favorite games with two or more players. The responses of the principal person 102 are recorded digitally both in terms of voice, and three-dimensional appearance with behavioral gestures.

In some examples, the analytic engine 106 can extract and transform game playing approaches of the principal person 102, such as including game playing strategies or abilities or both for one or more games. For instance, the analytic engine 106 can extract game playing approaches for games, such as checkers, chess, word games (e.g., Scrabble®), card games (e.g., poker, bridge, baccarat), board games (e.g., Clue®), role playing games (e.g., charades, Dungeons and Dragons®, Farmville), or other games. In some examples, the games are multiplayer games. The system, aided by the analytic engine 106, collects data indicative of the principal person's approach to playing games. For instance, the analytic engine 106 can guide the principal person 102 through a game to collect data indicative of how the principal person 102 manipulates configurations in the game, what strategies the principal person 102 tends to employ, with what skill level the principal person 102 plays the game (e.g., beginning, intermediate, or expert), or other data. The analytic engine 106 can collect and assess the behavior of the principal person 102 during the game, such as verbal responses, gestures, or other behavioral responses. In some cases, the analytic engine 106 can collect still or video images or audio recordings of the principal person 102 playing the game. In some cases, the analytic engine 106 can prompt the principal person 102 to provide stories about the game, such as memories the principal person 102 has about playing the game in the past, reasons why the principal person 102 likes the game, reasons why the principal person plays the game in a certain way, or other stories. In some cases, the analytic engine 106 can prompt the principal person 102 to identify his or her favorite games.

The system aided by the analytic engine 106 then creates a surrogate of the principal person 102 consisting of an avatar of the principal person 102 linked with the personal knowledge of the principal person 102 and the ontology of his world at that point in time. The avatar of the principal person is generated using the digitized three-dimensional video image of the principal person 102 parsed into behavioral expressions employed to morph the avatar's image, for example, facial expressions of the principal person 102 using software such as that of FaceShift.com and employing the principal person's voice to generate the avatar's voice in pitch and other sound attributes using articulatory synthesis and a database of speech units, which may amount to a billion or more for responding to arbitrary questions but some life stories or jokes may be recorded and used in their entirety.

In some examples, the surrogate of the principal person 102 can include the avatar of the principal person 102 linked with the game playing approaches of the principal person 102. The surrogate of the principal person 102 is able to play a game at the skill level (e.g., beginner, intermediate, expert) of the principal person 102. The avatar can exhibit the verbal responses. is assessed along with accompanying verbal responses, gestures, or other behavioral responses of the principal person 102 during the game. In general, the surrogate of the principal person 102 is able to reproduce the game play of the principal person based on the analysis, by the analytic engine 106, of the approach of the principal person 102 to the game, without having to anticipate or calculate the combinatorial number of steps or outcomes in the game.

The accuracy of the surrogate transformation is assessed 114 by the principal person 102 or a second person. The principal person 102 or a second person then interrogates the system's surrogate of the principal person using a script of frequently asked conventional questions or by presenting common game configurations for one or more games. If there are gaps or errors the process iterates until the performance of the surrogate of the principal person reaches a predetermined level of correctness in terms of this limited Turing Test.

As a result of the training and testing, the system enables the surrogate of the principal person 102 to answer general and specific questions and to execute a repertoire of multiperson games by means of an avatar matching in appearance, voice, manner and gesture the principal person 102 and by means of the analytic module 106 equipped with a digital representation of the transformed personal knowledge in the form of an ontology covering the lifetime of the principal person 102 using the techniques described by Gruber et al. (U.S. patent application Ser. No. 12/987,982, filed Jan. 10, 2011, the contents of which are incorporated herein by reference) to include an automated assistant receiving user input; an active ontology with representations of concepts and relations among concepts drawn from various databases of historical data and a language interpreter parsing the questioner's input to derive a representation of questioner's intent in terms of the active ontology. When the surrogate of the principal person 102 is able to play games according to the principal person's approach to those games, the ontology may include multiperson games, such as checkers, chess, word games (e.g., Scrabble®), card games (e.g., poker, bridge, or baccarat), role playing games (e.g., Clue®, Dungeons and Dragons®, or Farmville®), or other multiperson games.

Using the communications module 110 and the analytic module 106 the transformed digital representation of the principal person 102 is edited 116 for particular formats and audiences then communicated 118 when appropriate to that audience 120. So the surrogate of the principal person can be used to generate an interactive obituary, a digitized life history in the Story Corps sense or as a published autobiography using the book assembly techniques of Parker (Philip M. Parker, U.S. Pat. No. 7,266,767 B2, Sep. 4, 2007 Method and Apparatus for Automated Authoring and Marketing, which is incorporated by reference) or serve in place of the principal person 102 at a memorial service or at subsequent anniversaries or on special occasions.

It will be apparent, however, to one skilled in the art, that the framework described may be practiced using only voice communication or text communication and or more broadly for expertise in various domains. For example, a business may wish to deploy the expertise of one of its employees to several remote locations simultaneously and interactively or in the form of a manual or multimedia-based expert system.

FIG. 2 shows the conceptual framework 200 for the entering and execution of advance directives for future actions. The principal person 102 logs in to his account for Identification 204, to access identification information and all the information known or inferred by the analytic module that has been collected, organized and transformed into an intelligent personal assistant that can act as a surrogate when the principal person 102 becomes incompetent. The advance directives enable the system acting as the surrogate of the principal person to compose and deliver messages, to purchase gifts and arrange for their delivery to living persons specifically identifiable at the time the directives were entered or to persons unborn or not yet part of the social network; to convene and organize social gatherings to similarly chosen guests; and to engage in one or more social games involving two or more players. The principal person 102 initiates directives with a process of selection 206 of the occasion or event chosen from a set provided by the analytic module 106, then a designation 210 of the person or persons to be contacted and using the notification module specifies a future date of notification 214 or a means to determine a future date to be notified. When the system detects the said date has occurred the communication module 110 aided by analytic module 106 initiated a notification 216 of the person or person previously selected and manage carrying out the directives 218. For example the system with the aid of the analytic module 106 which can access an ontology of future time, can determine the birthday of selected individuals, analyze with the aid of the communication module 110 their preferences from their profiles then contact a vendor for a suitable gift and arrange for its delivery. In some embodiments, the analytics engine acts as a surrogate of a principal person 102 to generate responses (e. g., messages, and/or delivery instructions) based on historical data specific to the recipient 220. For instance, the analytics engine may be configured as described by Gruber et al. (U.S. patent application Ser. No. 12/987,982, filed Jan. 10, 2011, the contents of which are incorporated herein by reference) and by Basea-Forte et al (U.S. patent application Ser. No. 13/492,809 to include an automated assistant receiving user input; an active ontology with representations of concepts and relations among concepts drawn from various databases of historical; and a language interpreter parsing the publisher user input to derive a representation of principal person's intent in terms of the active ontology together with a services orchestration to output responses and instructions to implement the principal person's intent.

It will be apparent, however, to one skilled in the art, that the framework described may be practiced for more than communicating multimedia messages at future times, delivering gifts to relatives or friends on future occasions, or organizing future meetings and presentations, or interacting in multiperson games. For example, a business in the event of an emergency may wish to deploy the expertise of one of its employees to several remote locations simultaneously and interactively or in the form of a manual or multimedia-based expert system.

FIG. 3 is an exemplary configuration of a system 300 for embodiment of the present invention. The principal person 102 by means of his computing device 306, which is connected to the Internet 302, is enabled to generate a representational surrogate imbued with his personal knowledge and capable of discerning his intent for executing directives for future actions. The Internet 302 further connects to the analytic engine 106, the communication engine 110, the notification engine 208 and the services of a vendor 310. These engines and services draw upon internet-accessible databases on the network 304, which include the data and relationship supporting the lifetime ontology of the principal person 102 as well as the present and future ontologies in which the directives of the principal person 102 will be carried out. The communications, interactive presentations and directives of the principal person 102 are targeted at internet-enabled recipients 312.

FIG. 4 shows an exemplary embodiment of the editing interface 400 presented to the principal person 102. The internet-accessible computing device 402 is a means of presenting an avatar 410, which can be an interrogating avatar for interactively collecting life history information from the principal person 102 or for engaging in playing games with the principal person 102 or the avatar of the principal person to testing determine if the system surrogate has met a predetermined criterion of correctness. The window title 404 indicates the stage of surrogate development. The website URL is noted by 406. The video start button 408 can be clicked or commanded verbally to start the session. When the system surrogate has met the predetermined criterion of correctness the principal person 102 can proceed to set up directives future actions.

FIG. 5 is a view of an editing interface 500 for entering surrogate directives. The internet-accessible computing device 502 is a means of presenting an avatar of 510 to receive instructions by natural language dialog for executing future actions. The window title 506 indicates the type of directive being edited. The website URL is indicated by 504. A progress bar 508 indicates the steps completed and those steps still to be completed

FIG. 6 is a block diagram of the analytics engine 106 of the system 300. The analytics engine 106 facilitates identifying notification trigger events for significant event persons, curating an appropriate message upon notification, then publishing or delivery of communications in response to a significant event on behalf of principal person 102 by inferring information about the person described in the communication item from one or more data sources or determining or inferring milestone events for the recipient user 314 or for the person described in the communication item, among other things. The person described in the communication item may be the intended reader of the communication item, the publisher of the communication item, both the reader and the publisher, or neither the reader nor the publisher.

A predictive analytics module 602 in analytics engine 106 applies search algorithms and forecasting models stored in a search and forecasting models library 606 to analyze present and/or historical subject user data in view of data stored in a database 608 containing data related to identify milestone events and to suggest appropriate media messages or items for a reader user. The predictive analytics module 602 implements a variety of forecasting techniques beyond simple algorithms, such as future date calculation, including statistical techniques such as machine learning (e.g., as applied by IBM's Watson computer), game theory, and data mining, to analyze current and historical data to determine significant event triggers for notification, to make predictions about future readers, to identify communication media messages, and to identify appropriate delivery times and methods, among a wide variety of other analyses and algorithms. For example in the case of an autobiographical communication item of a grandfather (the publisher user), the reader user is the projected offspring of a current member in the system but the publisher user may incapacitated at the time of publication and delivery or both. By a computer-implemented method, data relevant to the publisher user may be extracted from his profile in the system 300 and/or generated implicitly based, at least in part, on the publisher user's stored profile together with historical data by a predictive analytics algorithm based on historical data. Based on the extracted or generated data, a significant event is identified, content for a communication is selected, appropriate reader users are identified, and/or other analysis is performed, in some cases without input from the publisher user.

In some examples, analytics engine 106 may use data specific to a user to identify potential milestone events (e.g., to identify a bar mitzvah date for a child based on the child's birth date or to identify appropriate religious holidays based on the user's specified religious affiliation or a prevailing religion in the region where the user lives). In some cases, the predictive analytics module 602 may also incorporate present or historical data or both to identify relevant information for the communication subject or reader user or both that are in keeping with preferences of the publisher user. In other examples, the analytics engine 106 analyzes publically available sources of information and/or private sources of information to which it has access, including. e.g., social networking facilities, online or mobile periodicals such as newspapers or magazines, and websites, to identify the occurrence of significant events associated with the reader user or with the person whom the communication is about. For instance, the analytics engine 106 may analyze trade journal websites to set up criteria so the notification engine 208 can identify when a target person receives an award or a promotion.

A display module 504 of the analytics engine 106 may display the significant events of an individual of interest (e.g., a reader user or another individual specified by the publisher user) on a webpage belonging to or accessible by the publisher user. These events with associated actions can be selected for notifications stored in the notification engine 208. In some embodiments, upon notification by the notification engine, the analytics engine 106 may automatically communicate messages of a significant event relevant to a reader user, such as a birthday, to the communication engine 110, which sends the notices to relatives of the reader user, who can act as publisher users. The analytics engine 106 may use information about a reader user found in various databases to determine when to send out the notices.

In some embodiments, the predictive analytics implemented by the analytics engine 106 incorporate the robust, optimizing forecasting techniques of Pinto et al. (U.S. Pat. No. 7,499,897, issued on Mar. 3, 2009; U.S. Pat. No. 7,562,058, issued on Jul. 14, 2009; U.S. Pat. No. 7,725,300, issued on May 25, 2010; U.S. Pat. No. 7,730,003, issued on Jun. 1, 2010; U.S. Pat. No. 7,933,762, issued on Apr. 26, 2011; U.S. Pat. No. 8,165,853, issued Apr. 24, 2012; U.S. Pat. No. 8,170,841, issued May 1, 2012; U.S. Pat. No. 8,751,273, issued on Jun. 10, 2014; and U.S. patent application Ser. No. 10/826,949, filed Apr. 16, 2004, the contents of all of which are incorporated herein by reference), that manage historical data using missing values, which must be inferred.

The analytics engine 106 can act as a surrogate for the principal person 102 by specifying communications, goods, and services or any other communication items for placement into storage. Provided the potential reader user 314 is registered in the system 300, the communication engine 110 will determine the location of the reader user, e.g., by GPS tracking or similar means. The reader user's interests and status may be available in the reader user's profile, which, taken together with historical data, enable the analytics engine 106 utilizing inferences from missing data, if necessary, to determine an appropriate gift to accompany the message and an optimal time for delivery. The delivery time is selected by a predictive analytics algorithm, based on historical data specific to the reader user.

In some embodiments, the analytics engine 106 acts as a surrogate of a principal person 102 to generate communication items (e.g., messages, sympathy tribute selections, and/or delivery instructions) or to engage in interactive games based on data, e.g., historical data, specific to the reader user. The interactive games may involve two or more people connected to a computer system in for instance, a chess or checkers game. The players can be present in a single room or can be remotely located, e.g., as in a multiplayer online battle arena game such as League of Legends® (published by Riot Games®) that can involve 7.5 million players concurrently during peak hours. For instance, the analytics engine may be configured as described by Gruber et al. (U.S. patent application Ser. No. 12/987,982, filed Jan. 10, 2011, the contents of which are incorporated herein by reference) to include an automated assistant receiving user input; an active ontology with representations of concepts and relations among concepts drawn from various databases of historical data (for instance, for the case in which the publisher user is the agent of a corporation, the corporate personnel database may be referenced); and a language interpreter parsing the publisher user input to derive a representation of publisher user intent in terms of the active ontology together with a services orchestration to output responses and instructions to implement the publisher user's intent. The automated assistant acting as the agent of a person, group of people, agency, government, corporation, or other entity may engage in role playing for negotiation. By a computer-implemented method, data relevant to the reader user may be extracted from his profile, generated implicitly based, at least in part, on the reader user's stored profile with the system together with historical data by a predictive analytics algorithm based on historical data, and/or obtained from publically available or privately accessible information sources. Based on the extracted or generated data a communication is selected, generated, and delivered, in some cases without input from the publisher user.

FIG. 7 is a block diagram 700 of a communication engine 110 of the system 300. The communication engine 110 facilitates identification of a significant event person along with criteria used by the notification engine 208 to trigger notification of the curator for composing a message, publishing or delivery of communication items, which may be an invitation to play a game for a principal person 102 by providing information about a reader user's physical location, profile interest information, and/or affinity information. In some examples, the location, interest, and affinity and other current and historical information may be displayed by a display module 704 on a webpage belonging to or accessible by the publisher user. The communication engine 110 includes an affinity database 702 for storing significant event person and reader user affinity information and a reader location database 710 for storing the physical location of a reader user. The reader location database 710 may receive data relevant to the location of a reader user from a GPS translation module 706 or may obtain the reader user's location from the analytic engine's analysis of websites or other sources of information. For example, the publisher user may have composed a sympathy note regarding an individual killed in an accident; the communication engine determines that the next of kin is traveling in another country and thus likely to be reachable by email but not by phone.

FIG. 8 is a block diagram 800 of a notification engine 208 of the system 300. The notification engine 208 facilitates publishing or delivery of communications for a principal person 102 by detecting significant events of interest to the principal person 102 such as an upcoming game or tournament as listed in a data file 802. For example, a publisher user may be notified about the death of friend by means of a search module 804 supported by a parsing and interpretation library 808. The publisher user may then compose and publisher or deliver a sympathy message to the friend's family. In some examples, information the individual whose significant event has been detected (referred to here as the tracked individual) may be displayed by a display module 806 on a webpage belonging to the publisher user. The notification engine 108 may also display the tracked individual's profile within the system 300 for confirmation of the individual's significant event.

FIG. 9 is a view 900 of a recipient interface. The internet-connected computing device 902 enables a multimedia display that shows an avatar of the principal person 910 programmed to deliver answers to natural language inquiries using the detailed knowledge of the principal person 102 previously collected, curated and transformed or to play a board game, word game, card game or video game at the level of skill of the principal person 102, in some cases with behavioral gestures or natural language comments or both acquired from the principal person 102

FIG. 10 is a flowchart of an example process 1000 for communicating a multimedia message in the system 300. In the process 1000, a principal person 102 has directed his surrogate with an occasion and a specific audience (1002). The surrogate using the communication engine (110) requests the profiles of the audience members (1004). The analytic engine then provides event constraints for the communication (1006). Using the notification engine 208 there is a pause for the first question of request (1008). When the question or request is received the intent is determined by the analytic engine (1012) and the response is prepared (1014). The communication engine using the surrogate avatar delivers the communication (1016). Then there is a pause for follow-up (1018) and the cycle repeats until the notification engine 208 determines the presentation is complete. Then there is a closure of the presentation (1020). The audience may be given the opportunity to acknowledge receipt and confirm delivery and even reply to the principal person 102 or to his proxy.

FIG. 11 is a flowchart of an example process 1100 for distributing a gift, game prize, or tribute in the system 300. In the process 1100, a principal person 102 has selected or set up a directive to select a recipient person (1102) and a particular gaming event (1104) and using the communication engine for profile of the person and analytic engine for predictive forecasting a gift or tribute is chosen (1106). Then there is a pause (1108) but at the appropriate date as determined by the notification engine (208) (1110) the recipient is located by means of the communication engine (110) (1112) using the current recipient profile for location (1114). Under the directives the system makes arrangement with a vendor (1116) using the analytics engine (106) for vendor selection (1118) and delivery time selection (1120). The gift vendor or another vendor then delivers the gift to the recipient (1122). The recipient 314D may be given the opportunity to acknowledge receipt and confirm delivery and to reply to the principal person 102 or the publisher user's proxy.

FIG. 12 shows a flowchart 1200 of the management of an advance event directive planned by the principal person 102 The principal person selects the type of event to host (1202), such as a social gathering or game tournament, and selects the attendees either directly (1204) or by description using profiles if available (1206). The principal person 102 then sets the date of the event or some triggering criterion, e.g., birthday party or graduation party (1208) and the venue directly or by description, e.g., function room at Waldorf Astoria in New York (1212). Based on the guest's profiles, the proxy surrogate selects the menu and caterer which may be the regular venue caterer (1214). In advance of the appropriate date or immediately after notice of the triggering event, the proxy surrogate of the principal person sends out the invitations (1216) using a service such as EventBrite™ to collect RSVPs (1220) then confirms the appropriate venue and catering arrangements (1222). Then the proxy surrogate arranges for an internet-accessible telepresence display (1224). On the date of the event, the proxy surrogate uses the telepresence display to attend the event and greet the attendees and during the event the proxy surrogate interacts with attendees, which may include participating in a game or tournament. At the end of the event the proxy surrogate thanks the attendees, coordinates with the caterer and venue provider and shuts off the telepresence display.

In some examples, the principal person 102 can organize a game event with specified participants to be played at a specified future time. FIG. 13 shows a flowchart 1300 of the management of a game event planned by the principal person 102. The principal person selects the type of game (1302), such as a word game like Scrabble, a categories game like Jeopardy, a card game like bridge or poker, or other multiperson game or game tournament, and selects the players either directly (1304) or by description using profiles if available (1306) and sends out invitations using a service such as EventBrite™ to collect RSVPs. A player could be a person who is interested in playing the game chosen or the surrogate of a person who had that game-playing skill. The principal person 102 then sets the date of the game event possibly based on some triggering criterion, e.g., birthday party or graduation party (1308). In some examples, the principal person 102 specifies the exact date of the game event (e.g., Nov. 18, 2020). In some examples, the principal person 102 indicates that the game event is to occur on the date of an event that is associated with a specific date, such as the tenth birthday of the principal person's youngest nephew. In some examples, the principal person 102 indicates that the game event is to occur on the date of an event whose date is not known at the time the principal person 102 organizes the game event. For instance, the principal person 102 can indicate that the game event is to occur on the night before the wedding of his oldest grandson, who is still unborn at the time the principal person 102 organizes the game event. The analytic engine 106 can determine a date for the game event based on the information provided by the principal person.

In some cases, the principal person 102 in advance or proxy surrogate of the principal person on the occasion can select an appropriate commercial sponsor for the game based criteria such as the profiles of the players, the type of game chosen, the appropriate type of prize or prizes (1310). By sponsor, we mean an entity, such as a business, whose logo, slogan, or another identifier appears during game play (e.g., on the game board, game pieces, cards, or on the screen). In some examples, the sponsor can offer prizes to one or more participants of the game. In some examples, the sponsor can be chosen using predictive analytics. The principal person programs the sponsor identification (1310) to arrange for an internet-accessible telepresence display of the proxy surrogate of the principal person 102 (1312) and the telepresence of the proxy surrogate of another person, if that proxy surrogate was chosen as a player. The proxy surrogate uses the telepresence display to attend the event and greet the attendees and during the game the proxy surrogate interacts with players, which may include playing the game or commenting on game play or on other topics. The game session and the interaction with the proxy surrogate can be an audio session, a video session, or a multimedia session. For instance, the proxy surrogate may carry on conversations with the players between moves of the game, e.g., to share commentary on game play strategies, the principal person's memories about the game or the players, or other topics. The proxy surrogate can engage in a natural conversation with the players on behalf of the principal person during the game, e.g., responding to questions or comments from the players based on the life history information previously collected from the principal person.

The players can be assembled together in a venue, e.g., a function room at Waldorf Astoria in New York (1314) or can be assembled virtually. e.g., over the internet. The proxy surrogate of the principal person 102 then initiates the game (1316) which can involve recording the multimedia game session or displaying the game session to spectators (e.g., through a simulcast) or both. Initiating the game can involve assignment of stakes, choosing of teams, or other aspects. The game session continues to the conclusion of the game (1318) at which point a second or subsequent game may be initiated, e.g., upon request of the proxy surrogate (e.g., acting on instructions from the principal person 102 to play a specified number of games) or upon request of one or more of the players (1320). At the conclusion of the gaming event (1322) the proxy surrogate thanks the attendees, distributes prizes to the game winner or winners, coordinates, if necessary, with the caterer and venue provider and shuts off the telepresence display after saving the gaming session to the archive.

In some cases, the game event is not scheduled in advance by the principal person. Rather, one or more players can access the gaming system to request that the proxy surrogate play a game on behalf of the principal person. In some cases, the players can specify the game to be played. In some cases, the players can request that the proxy surrogate select a game on behalf of the principal person, e.g., the principal person's favorite game.

FIG. 14 is a view 1400 of a gaming board interface. The user's internet-connected computing device 308 enables a multimedia display that shows a game board interface 1402 programmed to deliver over the internet or computer network 302 from a particular URL 1404 a game session 1406 in telepresence to all players in the game. In the particular game illustrated game (Scratch and Match) the object is to obtain matching pairs of numbers 1408 when the images of the cards are activated (“scratched”). Images, sounds, or voice interactions, or a combination of any two or more of them, had previously been collected from the principal person 102, curated, and transformed in order for the proxy surrogate of the principal person 102 to play this or a similar board game, word game, card game or video game at the level of skill of the principal person 102. The proxy surrogate determines a move or action in the game on behalf of the principal person in response to a move or action by one of the players, e.g., based on an analysis of the game situation at the level at which the principal person played the game.

In some examples, during game play, the proxy surrogate provides images of behavioral gestures, natural language comments acquired from or derived from the principal person 102. For instance, a video showing the principal person 102 playing the game can be shown during game play. In some cases, a reaction of the proxy surrogate to an occurrence during the game can be based on stored information from or about the principal person 102. For instance, if the proxy surrogate (playing on behalf of the principal person 102) earns a point in a game, the video can show the principal person clapping. In some cases, the proxy surrogate can react to a question or request from one of the players. For instance, a player can ask the proxy surrogate to jump. If the principal person 102 had previously recorded a video of himself jumping, the video can show the principal person 102 jumping. If there is no video recording that satisfies the player's request, the proxy surrogate can respond saying “Sorry, I don't feel like jumping right now.” In some cases, the players and the proxy surrogate can agree on an action that the proxy surrogate will do at the end of the game. For instance, the players and the proxy surrogate may agree that whoever loses the game has to turn around 10 times. If the proxy surrogate loses the game, the video can show the principal person 102 turning around 10 times.

In some examples, based on the profiles of the players, the proxy surrogate of the principal person 102 determines using the analytics engine 106 an appropriate sponsor of the game, contacts the sponsor using the communication engine 110 and upon receiving acceptance places the sponsor's logo on the game board display, for example on the cards 1410. If the sponsor had authorized a prize for the game, the proxy surrogate of the principal person 102 alerts the game players using the notification engine 208 and upon conclusion of the game uses the notification engine 208 to alert the vendor 210 to send the prize or prizes to the winning game players.

FIG. 15 shows a flowchart 1500 for managing a challenge to an interactive game event planned by the principal person 102. By a challenge to an interactive game event, we mean a request from a person to play a game with the proxy surrogate of the principal person. In some examples, any person is permitted to challenge the proxy surrogate of the principal person to a game, e.g., any person that knows how to access the proxy surrogate of the principal person on the game playing system. In some examples, only certain people (e.g., specified by the principal person) are permitted to challenge the proxy surrogate of the principal person to a game. For instance, the principal person 102 would have previously programmed or designated a screening procedure for the type of person or entity that would be an acceptable challenger for a game (1502). For instance, the principal person could have directly specified one or more people or entities, for example named friends or relatives or a proxy surrogate of a friend or relative. The principal person could have specified a characteristic indicative of an identity of one or more people or entities, for example by specifying a class of people (for example, great grandchildren) permitted to challenge the proxy surrogate of the principal person. If the principal person specifies a characteristic that does not directly identify a person or entity, the analytics engine can determine whether the person requesting the game satisfies the characteristic specified by the principal person.

In some cases, the principal person 102 would have previously programmed or designated a screening procedure for the type of acceptable game (1504), such as one known to the principal person 102, for example, a word game like Scrabble, a categories game like Jeopardy, a card game like bridge or poker, or other multiperson game or game tournament. In some cases, the analytics engine automatically determines which games are acceptable, e.g., based on which games the principal person played when setting up the game play system.

On the occasion of the game event, (1506) the proxy surrogate of the principal person 102 can determine (e.g., using predictive analytics) and select an appropriate commercial sponsor for the game based criteria such as the profiles of the players, the type of game chosen, the appropriate type of prize or prizes to selected the most probable sponsor of the game. The proxy surrogate contacts the sponsor (1508) and upon receiving acceptance places the sponsor's logo on the game board display (1510). If the sponsor had authorized a prize for the game, the proxy surrogate of the principal person 102 notifies the game players or proceeds with an unsponsored game.

The proxy surrogate of the principal person 102 then arranges for an internet-accessible telepresence display of the proxy surrogate of the principal person 102 (1512) and the telepresence of the proxy surrogate of another person, if that proxy surrogate was chosen as a player. The proxy surrogate uses the telepresence display to attend the event and greet the attendees and during the game the proxy surrogate interacts with players, which may include playing the game or commenting on game play or on other topics. The game session and the interaction with the proxy surrogate can be an audio session, a video session, or a multimedia session. For instance, the proxy surrogate may carry on conversations with the players between moves of the game, e.g., to share commentary on game play strategies, the principal person's memories about the game or the players, or other topics. The proxy surrogate can engage in a natural conversation with the players on behalf of the principal person during the game, e.g., responding to questions or comments from the players based on the life history information previously collected from the principal person.

The players can be assembled together in a venue, e.g., a function room at Waldorf Astoria in New York (1514) or can be assembled virtually, e.g., over the internet. The proxy surrogate of the principal person 102 then initiates the game (1516) which can involve recording the multimedia game session or displaying the game session to spectators or both. Initiating the game can involve assignment of stakes or choosing of teams or other aspects. The game session continues to the conclusion of the game (1518) at which point a second or subsequent game may be initiated (1520), e.g., upon request of the proxy surrogate or one or more of the players. At the conclusion of the gaming event (1522) the proxy surrogate thanks the attendees, distributes prizes to the game winner or winners, coordinates, if necessary, with the caterer and venue provider and shuts off the telepresence display after saving the gaming session to the archive database (316A, . . . 316N) so that it forms part of the history of the principal person 102.

The platform may be used for more than recreational gaming or sponsor marketing. For instance, the gaming platform can be used in business applications, e.g., for role playing of scenarios of product development and release; in government applications, e.g., for role playing of political or conflict scenarios, such as military war games; or in public health applications, e.g., for role playing of containment scenarios of infectious diseases, such as Ebola; or in other applications.

As desired, the gaming event social network may include more or fewer than the components illustrated.

The gaming event social network is described above with reference to block and flow diagrams of systems, methods, apparatuses, and/or computer program products according to examples. In some instances, the publisher and reader users may access the social network by desktop or laptop computers. In some embodiments, the publisher and reader users may access the social network by mobile devices such as smart phones. In some embodiments, the publisher and reader users may access the social network by tablet computers or any commercial computing device connected to the internet. In some cases, the social network may be constructed to operate on the internet independent of existing social networks. The gaming event social network may operate using existing social networks, e.g., Facebook, Google+, or Yammer as platforms using existing application interfaces open to website developers.

Generally, the intelligent automated assistant techniques disclosed herein may be implemented on hardware or a combination of software and hardware. For example, they may be implemented in an operating system kernel, in a separate user process, in a library package bound into network applications, on a specially constructed machine, or on a network interface card. In a specific embodiment, the techniques disclosed herein may be implemented in software such as an operating system or in an application running on an operating system.

Software/hardware hybrid implementation(s) of at least some of the intelligent automated assistant embodiment(s) disclosed herein may be implemented on a programmable machine selectively activated or reconfigured by a computer program stored in non-transitory memory. Such network devices may have multiple network interfaces which may be configured or designed to utilize different types of network communication protocols. A general architecture for some of these machines may appear from the descriptions disclosed herein. According to specific embodiments, at least some of the features and/or functionalities of the various intelligent automated assistant embodiments disclosed herein may be implemented on one or more general-purpose network host machines such as an end-user computer system, computer, network server or server system, mobile computing device (e.g., personal digital assistant, mobile phone, smartphone, laptop, tablet computer, or the like), consumer electronic device, music player, or any other suitable electronic device, router, switch, or the like, or any combination thereof. In at least some embodiments, at least some of the features and/or functionalities of the various intelligent automated assistant embodiments disclosed herein may be implemented in one or more virtualized computing environments (e.g., network computing clouds, or the like).

One or more blocks of the block diagrams and flow diagrams, and combinations of blocks in the block diagrams and flow diagrams, respectively, can be implemented by computer-executable program instructions. Some blocks of the block diagrams and flow diagrams may not necessarily need to be performed in the order presented, or may not necessarily need to be performed at all, in some cases.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a non-transitory computer-readable memory that can direct a computer or other programmable data processing apparatus to function in a particular manner, such that the instructions stored in the non-transitory computer-readable memory produce an article of manufacture including instruction means that implement one or more functions specified in the flow diagram block or blocks. As an example, embodiments may provide for a computer program product, comprising a non-transitory computer-usable medium having a non-transitory computer-readable program code or program instructions embodied therein, said non-transitory computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

While the gaming event social network has been described in connection with certain examples, is the system is not limited to the disclosed embodiments, but on the contrary, includes various modifications and equivalent arrangements. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i. e., one or more modules of computer program instructions encoded on a tangible non-transitory program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or communication data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Non-transitory computer readable media suitable for storing computer program instructions and data include all forms of non volatile memory, media and memory devices, including by way of example semiconductor memory devices, e.g., EPROM, EEPROM, and flash memory devices; magnetic disks. e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

Other implementations are also within the scope of the following claims.

1. A method comprising:
playing a game with a second person on behalf of a first person using a digital representation of the first person; and
on behalf of the first person and using the digital representation of the first person, while playing the game with the second person, providing a natural language response to a question or statement from the second person based on information from or about the first person.

2. The method of claim 1, comprising presenting the digital representation of the first person.

3. The method of claim 2, in which the digital representation of the first person includes one or more of an audio representation, a still image representation, or a video representation of the first person.

4. The method of claim 1, in which playing the game with the second person comprises playing the game at a level of play at which the first person plays or played the game.

5. The method of claim 4, comprising determining the level of play of the first person.

6. The method of claim 4, comprising determining the level of play of the first person based on a previous observation of the first person playing the game

7. The method of claim 1, in which playing the game with the second person includes presenting a gesture or physical action during the game.

8. The method of claim 7, comprising presenting the gesture or physical action in a video or multimedia display.

9. The method of claim 7, comprising determining the gesture or physical action based on information received from or about the first person.

10. The method of claim 9, comprising determining the gesture or physical action based on a previous observation of the first person playing the game.

11. The method of claim 7, comprising presenting the gesture or physical action in response to a question, statement, or action from the second person.

12. The method of claim 11, comprising determining the gesture or physical action based on the question, statement, or action from the second person.

13. The method of claim 7, comprising presenting the gesture or physical action in response to an event that occurred during the game.

14. The method of claim 1, comprising presenting a still or video image of the first person while playing the game with the second person.

15. The method of claim 1, comprising inviting the second person to play the game.

16. The method of claim 15, comprising determining an identity of the second person based on information indicative of the identity of the second person previously provided by the first person.

17. The method of claim 1, comprising receiving a request from the second person to play the game.

18. The method of claim 17, comprising determining whether to accept the request from the second person.

19. The method of claim 18, comprising accepting the request if information previously provided by the first person included information indicative of the identity of the second person.

20. The method of claim 1, in which providing the natural language response comprises providing at least a portion of a digitized life history previously provided by the first person.

21. The method of claim 20, comprising determining the portion of the digitized life history based on the question or statement from the second person.

22. The method of claim 1, in which providing the natural language response comprises providing the natural language response in a manner associated with the first person.

23. The method of claim 22, comprising determining the manner in which to provide the natural language response based on the information received from or about the first person.

24. The method of claim 22, in which the manner associated with the first person includes one or more of a manner of speaking by the first person or a gesture used by the first person.

25. The method of claim 24, in which the manner of speaking includes one or more of voice of the first person, an accent of the first person, or a tone of voice of the first person.

26. The method of claim 1, comprising playing the game with the second person on behalf of the first person when the first person is no longer alive or no longer competent.

27. A system comprising:
a processor coupled to a memory, the processor and memory configured to:
play a game with a second person on behalf of a first person using a digital representation of the first person; and
on behalf of the first person and using the digital representation of the first person, while playing the game with the second person, providing a natural language response to a question or statement from the second person based on information from or about the first person.

28. A computer readable medium storing instructions for causing a computing system to:
play a game with a second person on behalf of a first person using a digital representation of the first person; and
on behalf of the first person and using the digital representation of the first person, while playing the game with the second person, providing a natural language response to a question or statement from the second person based on information from or about the first person.
